(19) United States
(12) Patent Application Publication
(10) Pub. No.: US 2014/0174478 A1
(43) Pub. Date: Jun. 26, 2014

(54) DISHWASHING COMPOSITION

(71) Applicant: The Procter & Gamble Company, Cincinnati, OH (US)

(72) Inventors: Nathalie Sophie LETZELTER, Trimdon (GB); Sandrine VIALLET, North Shields (GB); Robby Renilde Francois KEULEERS, Lippelo (Sint-Amands) (BE)

(73) Assignee: The Procter & Gamble Company, Cincinnati, OH (US)

(21) Appl. No.: 14/103,917

(22) Filed: Dec. 12, 2013

(30) Foreign Application Priority Data
Dec. 21, 2012 (EP) 12199236.6

(51) Int. Cl. C11D 1/835; C11D 1/825; C11D 3/16; C11D 1/831

(52) U.S. Cl. CPC C11D 1/835; C11D 1/831; C11D 1/825; C11D 3/162
USPC 134/25.2; 510/220; 510/228

(57) ABSTRACT

An automatic dishwashing detergent composition containing a suds suppressor, a high foaming surfactant, a low foaming non-ionic surfactant, and a builder provides for superior cleaning without high levels of foam.

### FIELD OF THE INVENTION

The present invention is in the field of dishwashing. In particular, it relates to an automatic dishwashing detergent composition containing a suds suppressor, a high foaming surfactant, a low foaming non-ionic surfactant, and a builder.

### BACKGROUND OF THE INVENTION

Automatic dishwashing is an art very different from fabric laundering. Fabric laundering is normally done in purpose-built machines having a tumbling action. These are very different from automatic dishwashing machines which instead of having a tumbling action typically have a rotating spray arm with a plurality of jets that sprays cleaning solution onto the dishware. The spray arm rotation is created by pumping water into the arm. The pump action makes the dishwashing operation prone to foam formation. Foam can easily overflow the low sills of the dishwashing machines and slow down or stop the arm rotation due to having air and foam filling the arms instead of water, which in turn reduces the cleaning action and can even bring the dishwasher to a halt. Therefore, in the field of automatic dishwashing machines the use of foam-producing detergent components is normally restricted.

Automatic dishwashing detergent compositions are undergoing continual change and improvement. Typically, in other types of cleaning compositions such as laundry detergent compositions, cleaning improvements are made by changing and improving the surfactants used. However, as noted hereinbefore, automatic dishwashing detergent compositions have the unique limitation of requiring very low foaming, which is incompatible with most of the surfactant systems typically used in other cleaning compositions.

Currently, automatic dishwashing detergent compositions typically use low foaming non-ionic surfactants for filming and spotting prevention rather than for cleaning. The cleaning performance of the non-ionic surfactants used in automatic dishwashing has generally been very limited due to the requirement of low foam. Usually, low foaming non-ionic surfactants have limited solubility in the wash solution. The lack of solubility of such non-ionic surfactants greatly limits their cleaning abilities. Attempts at utilizing the more commonly used high foaming surfactants, such as anionic surfactants, have typically failed due to unacceptable foaming of such surfactants. Thus, there continues to be a need for automatic dishwashing detergent compositions containing surfactants which provide cleaning benefits without unacceptably high foaming. In addition, there is a need for automatic dishwashing detergent compositions that are more energy efficient especially at low temperatures.

### SUMMARY OF THE INVENTION

The present invention relates to an automatic dishwashing detergent composition. The composition comprises from about 0.1% to about 20% by weight of the composition of a high foaming surfactant; from about 0.5% to about 15% by weight of the composition of a low foaming non-ionic surfactant; from about 0.001% to about 5% by weight of the composition of a suds suppressor; from about 1% to about 50% by weight of the composition of a builder, wherein the automatic dishwashing detergent composition has a foam volume of less than about 30 ml, preferably less than about 20, more preferably less than about 10 ml per 250 ml of a 4.0 g/l solution at 45° C. according to the test method described herein.

The present invention also relates to a method of cleaning dishware in an automatic dishwashing machine comprising the step of subjecting the dishware to a washing liquor comprising the composition of the invention.

### DETAILED DESCRIPTION OF THE INVENTION

### Definitions and Test Methods

Within the context of this specification, each term or phrase below includes the following meaning or meanings:

“High Foaming Surfactant” means any surfactant having a foam volume of above 30 ml, preferably above 40 ml, more preferably above 50 ml, according to the test described herein.

“Low Foaming Surfactant” means any surfactant having a foam volume of less than 30 ml, preferably less than 20 ml, more preferably less than 10 ml, according to the test described herein.

“Foam Volume” of a defined system is assessed using a SITA FOAM Tester R2000 (SITA) from Sita Messtechnik GmbH. The equipment is used with the following settings:

| Temperature | 45° C. |
|---|---|
| Volume | 250 mL |
| Agitation speed | 1000 rpm |
| Agitation time | 10 s |
| Number of readings | 21 (including initial reading) |
| Number of repeats | 3 |

The solution to test is made at the desired temperature (45° C.) and poured into the reservoir beaker of the SITA when the water bath to which the beaker is connected has reached 45° C. After the SITA proceeds to a cleaning of the measurement beaker, a 250 mL sample is automatically taken from the reservoir beaker to the measurement beaker. The SITA does 21 successive measurements of foam volume after 10s agitation at 1000 rpm (1st reading, 10s agitation at 1000 rpm, 2^{nd} reading, 10s agitation at 1000 rpm, 3^{rd} reading, etc up to 21^{st} reading). After measurement beaker is drained and cleaned, the process is repeated two more times (3 repeats in total). The average of the three sets of data is calculated, generating an average curve of the foam volume as a function of the number of readings. The foam volume is defined from this average curve as the maximum foam volume reached over the 21 readings.

To define whether a surfactant is “low foaming” or “high foaming”, a solution is prepared as follow and is tested with the SITA method described herein. Adjusted water is firstly prepared from deionised water by adding 2.5 g/L of NaCl and 1M NaOH up to a pH of 10.3 at room temperature. The adjusted water is then heated up to 45° C. and the surfactant is added to this adjusted water at a level of 0.4 g/L on a 100% active weight basis.

To measure the foam volume of a detergent composition, a solution is prepared as follow and is tested with the SITA method described herein. Adjusted water is firstly prepared from deionised water by adding 2.5 g/L of NaCl and 1M NaOH up to a pH of 10.3 at room temperature. The adjusted water is then heated up to 45° C. and the detergent composition is added to this adjusted water at a level of 4 g/L.

“Cloud point,” as used herein, is a well known property of non-ionic surfactants which is the result of the surfactant becoming less soluble in water with increasing temperature; the temperature at which the appearance of a second phase is observable is referred to as the “cloud point.”

To measure cloud point, a solution of 0.4 g/l of non-ionic surfactant is prepared in adjusted deionised water which further contains 2.5 g/l of NaCl and pH adjusted to 10.3 at room temperature by addition of 1M NaOH solution. The temperature of the solution is brought down to about 10° C. by placing it in the fridge at 5° C. for 1 hour prior to readings. The solution is then slowly heated up to 55° C. and its absorbance is measured (using a SpectraMax M2 from Molecular Device at 500 nm) every about 2° C. Absorbance is then plotted vs. temperature to get the cloud point value. In this test, cloud point is defined as the temperature corresponding to an absorbance value of about 0.1. A “high cloud point” is defined as a cloud point of about 40° C., or above. A “low cloud point” is defined as a cloud point of less than about 40° C.

The “Hydrophilic-lipophilic balance” or HLB of a surfactant is the measure of the degree to which it is hydrophilic or lipophilic, determined by calculating values for the different regions of the molecule, as described by Griffin in 1949. Griffin's method for non-ionic surfactants as described in 1954 works as follows:

HLB=20*Mh/M

where “Mh” is the molecular mass of the hydrophilic portion of the molecule, and M is the molecular mass of the whole molecule, giving a result on a scale of 0 to 20. An HLB value of 0 corresponds to a completely lipophilic/hydrophobic molecule, and a value of 20 corresponds to a completely hydrophilic/lypophobic molecule.

Automatic dishwashing detergent formulators are always looking for compositions that are able to provide superior cleaning in the absence of foaming. Typically, low foaming surfactants have been used in detergent compositions to reduce foam generated by food and promote water sheeting to prevent filming and spotting, but not to aid in cleaning. While other surfactants such as anionic surfactants provide desirable cleaning benefits, they have not been used in automatic dishwashing detergent compositions due to the unacceptable foaming of such surfactants.

It has been surprisingly found that superior cleaning of dishware can be achieved, in the presence of low foaming, with an automatic dishwashing detergent composition comprising high foaming surfactants in combination with low foaming non-ionic surfactants, a suds suppressor, and a builder. Without intending to be bound by theory, it is believed that there is a synergistic suds control action between the low foaming nonionic surfactant and the suds suppressor, i.e. while the suds suppressor delays the foam generation, the nonionic surfactant causes a faster decay of the foam. These combined effects lead to hardly any foam being built up during cleaning. While the presence of high foaming surfactants is desirable, there is a risk of high foaming surfactants increasing deposition of salts onto dishware thus causing cloudiness. Therefore, builder is included in the composition to mitigate deposition and increase dishware shine.

In addition, the automatic dishwashing detergent composition comprising high foaming surfactants in combination with low foaming non-ionic surfactants, a suds suppressor, and a builder, is suited for use in cold wash cycles. In cold wash cycles (temperature below 50° C., more preferably below 40° C. and especially below 30° C.), the amount of foam generated by a high foaming surfactant throughout a wash cycle is less than in the case of a warm wash cycle. As such, an even broader range, or an even higher level, of high foaming surfactants are enabled for use through the combination with a low foaming non-ionic surfactant and suds suppressor at cold water wash cycles.

At low wash temperature conditions, the low cloud point surfactant will become foaming in its own right and the combination with the silicone suds suppressor become critical to achieve good performance and no foam regardless of the wash temperature chosen by the consumer.

### Low Foaming Surfactant

Low foaming non-ionic surfactants are included in the automatic dishwashing detergent composition at a level of from about 0.5% to about 15%; in another embodiment from about 1% to about 10%, in another embodiment from about 2% to about 7%, by weight of the composition.

While a wide range of non-ionic surfactants may be selected, the non-ionic surfactant should be a low foaming non-ionic surfactant, as defined above. Preferably, the low foaming non-ionic surfactant may be a low cloud point non-ionic surfactant, as defined above.

In one embodiment, the low foaming non-ionic surfactant has the formula

R₁(EO)ₐ(PO)_{b}(BO)_{c}

wherein R1 is a linear or branched C6 to C20 alkyl; a is from about 2 to about 30; b is from 0 to about 30; c is from about 0 to about 30; wherein b and c cannot both be 0 simultaneously. When c is equal to 0, then the surfactant has a hydrophile-lipophile balance value (HLB) of less than 10. Any combination of EO, PO, and BO, fulfilling the above criteria can be used. The EO, PO and/or BO moieties can have either random or block distribution.

Typical low cloud point, low foaming non-ionic surfactants include non-ionic alkoxylated surfactants, in one embodiment ethoxylated-propoxylated alcohol with an HLB value lower than about 10, BO containing alcohol alkoxylates and polyoxypropyl-ene/polyoxyethylene/polyoxypropylene (PO/EO/PO), (BO/EO/BO) reverse block polymers, (EO/PO/EO) reverse block polymers, (EO/BO/EO) reverse block polymers, and (EO/PO/BO) reverse block polymers.

Also, such low cloud point, low foaming non-ionic surfactants include, for example, ethoxylated-propoxylated alcohol (e.g., Olin Corporation's Poly-Tergent® SLF-18) and epoxy-capped poly(oxyalkylated) alcohols (e.g., Olin Corporation's Poly-Tergent® SLF-18B series of non-ionics, as described, for example, in WO 94/22800, published Oct. 13, 1994 by Olin Corporation).

Low cloud point, low foaming non-ionic surfactants additionally comprise a polyoxyethylene, polyoxypropylene block polymeric compound. Block polyoxyethylene-polyoxypropylene polymeric compounds include those based on ethylene glycol, propylene glycol, glycerol, trimethylolpropane and ethylenediamine as initiator reactive hydrogen compound. Certain of the block polymer surfactant compounds designated PLURONIC®, REVERSED PLURONIC®, and TETRONIC® by the BASF-Wyandotte Corp., Wyandotte, Mich., are suitable in ADD compositions of the invention. Examples include REVERSED PLURONIC® 25R2 and TETRONIC® 702. Examples of alcohol alkoxylates include PLURAFAC SLF180®, PLURAFAC LF224® by the BASF-Wyandotte Corp., ECOSURF EH-3® from Dow Corporation, MARLOX FK64, MARLOX FK86® and MARLOX OP1® from Sasol Corporation, and IMBENTIN® from KOLB Corporation.

In one embodiment, the low foaming surfactant is an alkoxylated alcohol comprising at least a propoxyl moiety or a butoxyl moiety. In another embodiment, the low foaming surfactant is an alkoxylated alcohol comprising any configuration of ethoxylated (EO), propoxylated (PO), butoxylated (BO) alcohols.

### High Foaming Surfactant

Suitable high foaming surfactants include anionic surfactants, non-ionic surfactant, cationic surfactants, zwitterionic surfactants and amphoteric surfactants. Any surfactant can be chosen that has a foam volume greater than about 30 ml, preferably greater than about 40 ml, more preferably greater than about 50 ml of 0.4 g/l solution at 45° C. as tested by the SITA test as described above.

High foaming surfactants are present in the automatic dishwashing detergent composition from about 0.1% to about 20%, in another embodiment from about 0.5% to about 15%, in another embodiment from about 1% to about 10%, in another embodiment from about 3% to about 10%, by weight of the composition.

### A. Anionic Surfactant

In one embodiment of the present invention, the high foaming surfactant is an anionic surfactant. Suitable anionic surfactants are alkyl sulfate, alkyl sulfonate, alkyl sulfosuccinates and/or alkyl sulfoacetate, or mixtures thereof; in one embodiment, alkyl sulfate and/or alkyl ethoxy sulfates; alkyl ethoxylation sulfate with an average ethoxylation of less than about 5, in another embodiment less than about 2, preferably less than about 1, or a combination of alkyl sulfates and/or alkyl ethoxy sulfates with an average ethoxylation degree less than 5, in one embodiment less than 3, in another embodiment less than 2, preferably less than 1.

Suitable sulphate surfactants may include water-soluble salts or acids of C₁₀-C₁₄ alkyl or hydroxyalkyl, sulphate and/or ether sulfate. Suitable counterions include hydrogen, alkali metal cation or ammonium or substituted ammonium. Where the hydrocarbyl chain is branched, it comprises C₁₋₄ alkyl branching units. The average percentage branching of the sulphate surfactant is from about 10% to about 100%, in another embodiment 30% to about 90%, in another embodiment from about 35% to about 80%, and in another embodiment from about 40% to about 60% of the total hydrocarbyl chains.

Other suitable anionic surfactants are alkyl, dialkyl, sulfosuccinates and/or sulfoacetate. The dialkyl sulfosuccinates may be a C₆₋₁₅ linear or branched dialkyl sulfosuccinate. The alkyl moieties may be asymmetrical (i.e., different alkyl moieties) or symmetrical (i.e., the same alkyl moieties).

The composition of the present invention may comprise a sulphonate surfactant. Those include water-soluble salts or acids of C₁₀-C₁₄ alkyl or hydroxyalkyl, sulphonates; C₁₁-C₁₈ alkyl benzene sulphonates (LAS), modified alkylbenzene sulphonate (MLAS); methyl ester sulphonate (MES); and alpha-olefin sulphonate (AOS). Those also include the paraffin sulphonates may be monosulphonates and/or disulphonates, obtained by sulphonating paraffins of 10 to 20 carbon atoms. The sulfonate surfactant also include the alkyl glyceryl sulphonate surfactants.

### B. Amphoteric and Zwitterionic Surfactants

Suitable amphoteric and zwitterionic surfactants are amine oxides and betaines. In one embodiment the surfactant is an amine oxide, especially coco dimethyl amine oxide or coco amido propyl dimethyl amine oxide. Amine oxides may have a linear or mid-branched alkyl moiety. Typical linear amine oxides include water-soluble amine oxides containing one R1 C₈₋₁₈ alkyl moiety and 2 R2 and R3 moieties selected from the group comprising C₁₋₃ alkyl groups and C₁₋₃ hydroxyalkyl groups. Amine oxides are characterized by the formula R1-N(R2)(R3) O wherein R₁ is a C₈₋₁₈ alkyl and R₂ and R₃ are selected from the group consisting of methyl, ethyl, propyl, isopropyl, 2-hydroxyethyl, 2-hydroxypropyl, 3-hydroxypropyl, and mixtures thereof. The linear amine oxide surfactants in particular may include linear C₁₀-C₁₈ alkyl dimethyl amine oxides and linear C₈-C₁₂ alkoxy ethyl dihydroxy ethyl amine oxides. Amine oxides include linear C₁₀, linear C₁₀-C₁₂, and linear C₁₂-C₁₄ alkyl dimethyl amine oxides. As used herein “mid-branched” means that the amine oxide has one alkyl moiety having n₁ carbon atoms with one alkyl branch on the alkyl moiety having n₂ carbon atoms. The alkyl branch is located on the α carbon from the nitrogen on the alkyl moiety. This type of branching for the amine oxide is also known in the art as an internal amine oxide. The total sum of n₁ and n₂ is from 10 to 24 carbon atoms, from 12 to 20, and from 10 to 16. The number of carbon atoms for the one alkyl moiety (n₁) should be approximately the same number of carbon atoms as the one alkyl branch (n₂) such that the one alkyl moiety and the one alkyl branch are symmetric.

The amine oxide may further comprise two moieties, independently selected from a C₁₋₃ alkyl, a C₁₋₃ hydroxyalkyl group, or a polyethylene oxide group containing an average of from about 1 to about 3 ethylene oxide groups. In one embodiment the two moieties are selected from a C₁₋₃ alkyl, in another embodiment both are selected as a C₁ alkyl.

Other suitable surfactants include betaines such alkyl betaines, alkylamidobetaine, amidazoliniumbetaine, sulfobetaine (INCI Sultaines) as well as a phosphobetaine having the formula:

R¹—[CO—X(CH₂)ₙ]ₓ—N⁺(R²)(R₃)—(CH₂)ₘ—[CH(OH)—CH₂]_{y}—Y—(I) wherein

R¹ is a saturated or unsaturated C6-22 alkyl residue, in one embodiment C8-18 alkyl residue, in particular a saturated C10-16 alkyl residue, for example a saturated C12-14 alkyl residue;
X is NH, NR⁴ with C1-4 Alkyl residue R⁴, O or S;
n a number from 1 to 10, in one embodiment 2 to 5, in particular 3;
x is 0 or 1, in one embodiment x is 1;
R², R³ are independently a C1-4 alkyl residue, potentially hydroxy substituted such as a hydroxyethyl, in one embodiment a methyl;
m a number from 1 to 4, in particular 1, 2 or 3;
y is 0 or 1; and
Y is COO, SO3, OPO(OR⁵)O or P(O)(OR⁵)O, whereby R⁵ is a hydrogen atom H or a C1-4 alkyl residue.

Examples of suitable betaines and sulfobetaine are the following [designated in accordance with INCI]: Almondamidopropyl of betaines, Apricotam idopropyl betaines, Avocadamidopropyl of betaines, Babassuamidopropyl of betaines, Behenam idopropyl betaines, Behenyl of betaines, betaines, Canolam idopropyl betaines, Capryl/Capram idopropyl betaines, Carnitine, Cetyl of betaines, Cocamidoethyl of betaines, Cocam idopropyl betaines, Cocam idopropyl Hydroxysultaine, Coco betaines, Coco Hydroxysultaine, Coco/Oleam idopropyl betaines, Coco Sultaine, Decyl of betaines, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl of PG-betaines, Erucam idopropyl Hydroxysultaine, Hydrogenated Tallow of betaines, Isostearam idopropyl betaines, Lauram idopropyl betaines, Lauryl of betaines, Lauryl Hydroxysultaine, Lauryl Sultaine, Milkam idopropyl betaines, Minkamidopropyl of betaines, Myristam idopropyl betaines, Myristyl of betaines, Oleam idopropyl betaines, Oleam idopropyl Hydroxysultaine, Oleyl of betaines, Olivamidopropyl of betaines, Palmam idopropyl betaines, Palm itam idopropyl betaines, Palmitoyl Carnitine, Palm Kernelam idopropyl betaines, Polytetrafluoroethylene Acetoxypropyl of betaines, Ricinoleam idopropyl betaines, Sesam idopropyl betaines, Soyam idopropyl betaines, Stearam idopropyl betaines, Stearyl of betaines, Tallowam idopropyl betaines, Tallowam idopropyl Hydroxysultaine, Tallow of betaines, Tallow Dihydroxyethyl of betaines, Undecylenam idopropyl betaines and Wheat Germam idopropyl betaines.

### C. Non-Ionic Surfactants

Suitable high foaming non-ionic surfactants may include alcohol alkoxylate surfactants which have a cloud point of greater than 40° C., preferably greater than 45° C. High foaming non-ionic surfactants include alkoxylated surfactants having only ethoxy groups derived from primary alcohol, and ethoxylated, propoxylated alcohols with an HLB value of greater than about 10.

Suitable high foaming non-ionic surfactants include alcohol ethoxylates and alcohol propoxylate/ethoxylate (PO/EO groups only) having a hydrophile-lipophile balance (HLB) value of greater than 10. Suitable non-ionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly included are the condensation products of alcohols having an alkyl group containing from 10 to 18 carbon atoms, in another embodiment from 10 to 15 carbon atoms with from 2 to 18 moles, 2 to 15, in another embodiment 5-12 of ethylene oxide per mole of alcohol.

High foaming non-ionic surfactants may additionally comprise a polyoxyethylene, polyoxypropylene polymeric compound when having an HLB value greater than 10. Block polyoxyethylene-polyoxypropylene polymeric compounds include those based on ethylene glycol, propylene glycol, glycerol, trimethylolpropane and ethylenediamine as reactive hydrogen compound. Examples of high foaming non-ionic surfactant include Marlipal 24/70® from Sasol Corporation, Tergitol 15S7®, Tergitol 15S40® and Tergitol L64® from Dow Corporation, and Lutensol TO7® from BASF-Wyandotte Corp.

Also suitable are alkylpolyglycosides having the formula R²O(CₙH₂ₙO)ₜ(glycosyl)ₓ wherein R² is selected from the group consisting of alkyl, alkyl-phenyl, hydroxyalkyl, hydroxyalkylphenyl, and mixtures thereof in which the alkyl groups contain from 10 to 18, from 12 to 14, carbon atoms; n is 2 or 3, in one embodiment 2; t is from 0 to 10, in one embodiment 0; and x is from 1.3 to 10, from 1.3 to 3, in one embodiment from 1.3 to 2.7. The glycosyl is derived from glucose. Also suitable are alkylglycerol ethers and sorbitan esters.

Also suitable are fatty acid amide surfactants having the formula (IV):

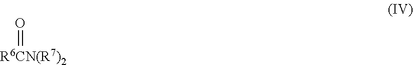

wherein R⁶ of formula (IV) is an alkyl group containing from 7 to 21, in another embodiment from 9 to 17 carbon atoms and each R⁷ of formula (IV) is selected from the group consisting of hydrogen, C₁-C₄ alkyl, C₁-C₄ hydroxyalkyl, —(C₂H₄O)ₓ, and mixtures thereof; where x of formula (IV) varies from 1 to 3. In one embodiment, amides are C₈-C₂₀ ammonia amides, monoethanolamides, diethanolamides, and isopropanolamides.

### D. Cationic Surfactants

Suitable cationic surfactants are quaternary ammonium surfactants. Suitable quaternary ammonium surfactants are selected from the group consisting of mono C₆-C₁₆, C₆-C₁₀N-alkyl or alkenyl ammonium surfactants, wherein the remaining N positions are substituted by methyl, hydroxyethyl or hydroxypropyl groups. Other cationic surfactants include alkyl benzalkonium halides and derivatives thereof, such as those available from Lonza under the BARQUAT and BARDAC tradenames. Another cationic surfactant is an C₆-C₁₈ alkyl or alkenyl ester of a quaternary ammonium alcohol, such as quaternary chlorine esters. In one embodiment, the cationic surfactants have the formula (V):

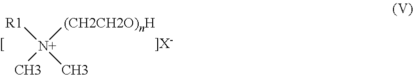

wherein R1 of formula (V) is C₈-C₁₈ hydrocarbyl and mixtures thereof, in one embodiment C₈₋₁₄ alkyl, in another embodiment C₈, C₁₀ or C₁₂ alkyl, and X of formula (V) is an anion, in one embodiment chloride or bromide.

### Suds Suppressor

Suds suppressors can be an alkyl phosphate ester suds suppressor, a silicone suds suppressor, or combinations thereof. Suds suppressor technology and other defoaming agents useful herein are documented in “Defoaming, Theory and Industrial Applications,” Ed., P. R. Garrett, Marcel Dekker, N.Y., 1973, incorporated herein by reference.

Suds suppressors are included in the automatic dishwashing detergent composition. The suds suppressor is included in the composition at a level of from about 0.0001% to about 10%, in another embodiment from about 0.001% to about 5%, from about 0.01% to about 1.5%, from about 0.01% to about 0.5%, by weight of the composition.

In one embodiment, the suds suppressor is a silicone based suds suppressor. Silicone suds suppressor technology and other defoaming agents useful herein are extensively documented in “Defoaming, Theory and Industrial Applications”, Ed., P. R. Garrett, Marcel Dekker, N.Y., 1973, ISBN 0-8247-8770-6, incorporated herein by reference. See especially the chapters entitled “Foam control in Detergent Products” (Ferch et al) and “Surfactant Antifoams” (Blease et al). See also U.S. Pat. Nos. 3,933,672 and 4,136,045. In one embodiment, the silicone based suds suppressors is polydimethylsiloxanes having trimethylsilyl, or alternate end blocking units may be used as the silicone. These may be compounded with silica and/or with surface-active nonsilicon components, as illustrated by a suds suppressor comprising 12% silicone/silica, 18% stearyl alcohol and 70% starch in granular form. A suitable commercial source of the silicone active compounds is Dow Corning Corp. Silicone based suds suppressors are useful in that the silica works well to suppress the foam generated by the high foaming non-ionic surfactant.

In one embodiment, the silicone based suds suppressor comprises solid silica, in another embodiment, a silicone fluid, in another embodiment a silicone resin, in another embodiment, silica.

In one embodiment, the silicone based suds suppressor is in the form of a granule, in another embodiment, a liquid.

In one embodiment, the silicone based suds suppressor comprises dimethylpolysiloxane, a hydrophilic polysiloxane compound having polyethylenoxy-propylenoxy group in the side chain, and a micro-powdery silica.

A phosphate ester suds suppressor may also be used. Suitable alkyl phosphate esters contain from 16-20 carbon atoms. Such phosphate ester suds suppressors may be monostearyl acid phosphate or monooleyl acid phosphate or salts thereof, in one embodiment alkali metal salts.

Other suitable suds suppressors are calcium precipitating fatty acid soaps. However, it has been found to avoid the use of simple calcium-precipitating soaps as antifoams in the present composition as they tend to deposit on dishware. Indeed, fatty acid based soaps are not entirely free of such problems and the formulator will generally choose to minimize the content of potentially depositing antifoams in the instant composition.

In one embodiment, the weight ratio of suds suppressor to low foaming non-ionic surfactant to high foaming, preferably anionic, surfactant is from about 1:9:3 to about 1:35:11, preferably from about 1:15:5 to about 1:29:9, more preferably from about 1:19:6 to about 1:25:8 by weight of the composition.

### Builder

In addition to their conventional role as chelating agents, builders are included in the composition to mitigate the deposition of salts onto dishware that can be caused by the inclusion of anionic surfactants. Builders for use herein include inorganic builders and organic builders. Builders are used in a level of from about 1 to 60%, in another embodiment from about 10 to 50% by weight of the composition. In some embodiments the composition comprises a mixture of inorganic and organic builders.

Inorganic builders include carbonates and phosphate builders, in particular mono-phosphates, di-phosphates, tri-polyphosphates or oligomeric-poylphosphates. In one embodiment, the alkali metal salts of these compounds are the sodium salts. In one embodiment, the builder is sodium tripolyphosphate (STPP).

Organic builders include amino acid based compounds, in particular MGDA (methyl-glycine-diacetic acid), GLDA (glutamic-N,N-diacetic acid), iminodisuccinic acid (IDS), carboxymethyl inulin and salts and derivatives thereof. In one embodiment, GLDA (salts and derivatives thereof) is the builder, in another embodiment specifically the tetrasodium salt.

Other suitable organic builders include amino acid based compound or a succinate based compound. The term “succinate based compound” and “succinic acid based compound” are used interchangeably herein. Other suitable builders are described in U.S. Pat. No. 6,426,229. Particular suitable builders include; for example, aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), IDS (iminodiacetic acid) and salts and derivatives thereof such as N-methyliminodiacetic acid (MIDA), alpha-alanine-N,N-diacetic acid (alpha-ALDA), serine-N,N-diacetic acid (SEDA), isoserine-N,N-diacetic acid (ISDA), phenylalanine-N,N-diacetic acid (PHDA), anthranilic acid-N, N-diacetic acid (ANDA), sulfanilic acid-N,N-diacetic acid (SLDA), taurine-N,N-diacetic acid (TUDA) and sulfomethyl-N,N-diacetic acid (SMDA) and alkali metal salts or ammonium salts thereof.

Carboxymethyl inulin is also a non-phosphate builder suitable for use herein. Carboxymethyl inulin is a carboxyl-containing fructan where the carboxyl is carboxymethyl and the fructan has β-2,1 bond. The carboxymethyl inulin is typically supplied as an alkali metal salt such as sodium carboxymethyl inulin. A suitable source of the carboxymethyl inulin is Dequest SPE 15625 from Thermphos International. The carboxymethyl inulin may have a degree of substitution ranging from about 1.5 to about 3, and may in some embodiments be about 2.5.

Other organic builders include polycarboxylic acids. Suitable polycarboxylic acids are acyclic, alicyclic, heterocyclic and aromatic carboxylic acids, in which case they contain at least two carboxyl groups which are in each case separated from one another by no more than two carbon atoms. Polycarboxylates which comprise two carboxyl groups include, for example, water-soluble salts of, malonic acid, (ethyl enedioxy) diacetic acid, maleic acid, diglycolic acid, tartaric acid, tartronic acid and fumaric acid. Polycarboxylates which contain three carboxyl groups include, for example, water-soluble citrate. Correspondingly, a suitable hydroxycarboxylic acid is, for example, citric acid.

Amino phosphonates are also suitable for use as builders and include ethylenediaminetetrakis (methylenephosphonates) as DEQUEST. In one embodiment, these amino phosphonates do not contain alkyl or alkenyl groups with more than about 6 carbon atoms.

### Cleaning Actives

Any traditional cleaning ingredients can be used as part of the automatic dishwashing detergent composition. The cleaning composition contains a phosphate builder or a non-phosphate builder, a high foaming surfactant system, a low foaming nonionic surfactant, and a suds suppressor. The composition may comprise one or more further detergent active components which may be selected from alkalinity sources, enzymes, polymers, bleaches, anti-corrosion agents (e.g. sodium silicate), metal care agents, and any other cleaning components typically known in the art of automatic dishwashing compositions.

### Polymer

A variety of polymers may be used in the automatic dishwashing detergent composition. In one embodiment, the polymer is formed by at least the following monomers: (i) a carboxylic acid containing monomer; (ii) a sulfonic acid group containing monomer; and (iii) optionally further an ionic or nonionogenic monomer.

Suitable polymers with sulfonated/carboxylated monomers described herein may have a weight average molecular weight of less than or equal to about 100,000 Da, or less than or equal to about 75,000 Da, or less than or equal to about 50,000 Da, or from about 3,000 Da to about 50,000, in another embodiment from about 4,500 Da to about 20,000 Da, in another embodiment from about 8,000 Da to about 10,000 Da.

In one embodiment, the polymer is selected to have one or more copolymers of unsaturated or saturated carboxylic acid monomers. Carboxylic acid monomers include one or more of the following: acrylic acid, maleic acid, itaconic acid, methacrylic acid, or ethoxylate esters of acrylic acids, acrylic and methacrylic acids. In one embodiment, the carboxylic acid is (meth)acrylic acid.

In another embodiment, the polymer is selected to have one or more monomers containing sulfonic acid groups. Sulfonated monomers include one or more of the following: sodium (meth) allyl sulfonate, vinyl sulfonate, sodium phenyl (meth) allyl ether sulfonate, or 2-acrylamido-methyl propane sulfonic acid. In one embodiment, the unsaturated sulfonic acid monomer is most 2-acrylamido-2-propanesulfonic acid (AMPS).

In a further embodiment, the polymer is selected to include ionic or nonionogenic monomers. Non-ionic monomers include one or more of the following: methyl (meth)acrylate, ethyl (meth)acrylate, t-butyl (meth)acrylate, methyl (meth) acrylamide, ethyl (meth) acrylamide, t-butyl (meth) acrylamide, styrene, or α-methyl styrene.

In one embodiment, the polymer comprises the following levels of monomers: from about 40 to about 90%, in another embodiment from about 60 to about 90% by weight of the polymer of one or more carboxylic acid monomer; from about 5 to about 50%, in another embodiment from about 10 to about 40% by weight of the polymer of one or more sulfonic acid monomer; and optionally from about 1% to about 30%, in one embodiment from about 2 to about 20% by weight of the polymer of one or more non-ionic monomer. In one embodiment the polymer comprises about 70% to about 80% by weight of the polymer of at least one carboxylic acid monomer and from about 20% to about 30% by weight of the polymer of at least one sulfonic acid monomer.

Examples of commercial available polymers include: Acusol 587G and Acusol 588G supplied by Dow (formerly Rohm & Haas)

Once added to the automatic dishwashing detergent composition, the polymer may be present in the automatic dishwashing detergent composition in an amount from about 0.5% to about 50%, in another embodiment from about 5% to about 35%, in another embodiment from about 5% to about 15% by weight of the total composition.

### Silicates

Silicates, if present, are at a level of from about 1 to about 20%, in one embodiment from about 5 to about 15% by weight of the composition. In one embodiment, silicates are sodium silicates such as sodium disilicate, sodium metasilicate and crystalline phyllosilicates.

### Metal Care Agents

Metal care agents may be included in the composition to prevent or reduce the tarnishing, corrosion, or oxidation of metals, including aluminium, stainless steel and non-ferrous metals, such as silver and copper. Suitable examples include one or more of the following:

(a) benzotriazoles, including benzotriazole or bis-benzotriazole and substituted derivatives thereof. Benzotriazole derivatives are those compounds in which the available substitution sites on the aromatic ring are partially or completely substituted. Suitable substituents include linear or branch-chain C1-C20-alkyl groups and hydroxyl, thio, phenyl or halogen such as fluorine, chlorine, bromine and iodine.

(b) metal salts and complexes chosen from the group consisting of zinc, manganese, titanium, zirconium, hafnium, vanadium, cobalt, gallium and cerium salts and/or complexes, the metals being in one of the oxidation states II, III, IV, V or VI. In one aspect, suitable metal salts and/or metal complexes may be chosen from the group consisting of Mn(II) sulphate, Mn(II) citrate, Mn(II) stearate, Mn(II) acetylacetonate, K2TiF6, K2ZrF6, CoSO4, Co(NO3)₂ and Ce(NO3)3, zinc salts, for example zinc sulphate, hydrozincite or zinc acetate.

(c) silicates, including sodium or potassium silicate, sodium disilicate, sodium metasilicate, crystalline phyllosilicate and mixtures thereof. In one embodiment, the metal care agent is a zinc salt.

If present, the composition of the invention comprises from about 0.1% to about 5%, or from about 0.2% to about 4%, or from about 0.3% to about 3% by weight of the total composition of a metal care agent.

### Enzyme

Suitable enzymes for use in the automatic dishwashing detergent composition include proteases such as metalloproteases and serine proteases. Suitable proteases include those of animal, vegetable or microbial origin. Chemically or genetically modified mutants are included.

Commerically available protease enzymes include those sold under the trade names Alcalase®, Savinase®, Primase®, Durazym®, Polarzyme®, Kannase®, Liquanase®, Ovozyme®, Neutrase®, Everlase® and Esperase® by Novo Nordisk A/S (Denmark), those sold under the tradename Maxatase®, Maxacal®, Maxapem®, Properase®, Purafect®, Purafect Prime®, Purafect Ox®, FN3®, FN4®, Purafect OXP® and Excellase® by Genencor International, and those sold under the tradename Opticlean® and Optimase® by Solvay.

In one embodiment, the cleaning composition of the invention comprises at least 0.001 mg of active protease. In further embodiments, the composition comprises a high level of protease, in particular at least 0.1 mg of active protease per gram of composition. In one embodiment, levels of protease in the compositions of the invention include from about 1.5 to about 10, in another embodiment from about 1.8 to about 5, and in another embodiment from about 2 to about 4 mg of active protease per gram of composition.

In another embodiment, the enzyme is an amylase. Suitable alpha-amylases include those of bacterial or fungal origin. Chemically or genetically modified mutants (variants) are included. Suitable commercially available alpha-amylases are DURAMYL®, LIQUEZYME® TERMAMYL®, TERMAMYL ULTRA®, NATALASE®, SUPRAMYL®, STAINZYME®, STAINZYME PLUS®, FUNGAMYL® and BAN® (Novozymes A/S), BIOAMYLASE-D(G), BIOAMYLASE® L (Biocon India Ltd.), KEMZYM® AT 9000 (Biozym Ges. m.b.H, Austria), RAPIDASE®, PURASTAR®, OPTISIZE HT PLUS® and PURASTAR OXAM® (Genencor International Inc.) and KAM® (KAO, Japan). In one embodiment, amylases are NATALASE®, STAINZYME® and STAINZYME PLUS® and mixtures thereof.

In one embodiment, the composition comprises at least 0.001 mg of active amylase. In one embodiment high level of amylase is used, at least 0.05 mg of active amylase per gram of composition, in another embodiment from about 0.1 to about 10, in another embodiment from about 0.25 to about 6, in another embodiment from about 0.3 to about 4 mg of active amylase per gram of composition.

### Bleach

Inorganic and organic bleaches are suitable cleaning actives for use herein. Inorganic bleaches include perhydrate salts such as perborate, percarbonate, perphosphate, persulfate and persilicate salts. The inorganic perhydrate salts are normally the alkali metal salts. The inorganic perhydrate salt may be included as the crystalline solid without additional protection. Alternatively, the salt can be coated.

Alkali metal percarbonates, particularly sodium percarbonate are perhydrates for use herein. The percarbonate may be incorporated into the composition in a coated form which provides in-product stability. A suitable coating material providing stability comprises mixed salt of a water-soluble alkali metal sulphate and carbonate. The weight ratio of the mixed salt coating material to percarbonate lies in the range from 1:200 to 1:4, in another embodiment from 1:99 to 1 9, and in another embodiment from 1:49 to 1:19. In one embodiment, the mixed salt is of sodium sulphate and sodium carbonate which has the general formula Na₂S0₄.n.Na₂CO₃ wherein n is from 0.1 to 3, in one embodiment n is from 0.3 to 1.0 and in another embodiment n is from 0.2 to 0.5.

Another suitable coating material providing stability comprises sodium silicate of Si02: Na₂0 ratio from 1.8:1 to 3.0:1, in another embodiment L8:1 to 2.4:1, and/or sodium metasilicate, applied at a level of from 2% to 10%, (normally from 3% to 5%) of Si02 by weight of the inorganic perhydrate salt. Magnesium silicate can also be included in the coating. Coatings that contain silicate and borate salts or boric acids or other inorganics are also suitable. Other coatings which contain waxes, oils, fatty soaps can also be used advantageously within the present invention. Potassium peroxymonopersulfate is another inorganic perhydrate salt of utility herein.

Typical organic bleaches are organic peroxyacids including diacyl and tetraacylperoxides, especially diperoxydodecanedioc acid, diperoxytetradecanedioc acid, and diperoxyhexadecanedioc acid. In one embodiment, dibenzoyl peroxide is an organic peroxyacid herein. The diacyl peroxide, especially dibenzoyl peroxide, should be present in the form of particles having a weight average diameter of from about 0.1 to about 100 microns, in another embodiment from about 0.5 to about 30 microns, and in another embodiment from about 1 to about 10 microns. In one embodiment, at least about 25% of the particles are smaller than 10 microns, in another embodiment at least about 50%, in another embodiment at least about 75%, and in another embodiment at least about 90%. Diacyl peroxides within the above particle size range have also been found to provide better stain removal especially from plastic dishware, while minimizing undesirable deposition and filming during use in automatic dishwashing machines, than larger diacyl peroxide particles.

Further typical organic bleaches include the peroxy acids, particular examples being the alkylperoxy acids and the arylperoxy acids. Representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

### Bleach Activators

Bleach activators are typically organic peracid precursors that enhance the bleaching action in the course of cleaning at temperatures of 60° C. and below. Bleach activators suitable for use herein include compounds which, under perhydrolysis conditions, give aliphatic peroxoycarboxylic acids having from 1 to 10 carbon atoms, in particular from 2 to 4 carbon atoms, and/or optionally substituted perbenzoic acid. Suitable substances bear O-acyl and/or N-acyl groups of the number of carbon atoms specified and/or optionally substituted benzoyl groups. In one embodiment is polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC). Bleach activators if included in the compositions of the invention are in a level of from about 0.1 to about 10%, from about 0.5 to about 2% by weight of the composition.

### Bleach Catalyst

Bleach catalysts for use herein include the manganese triazacyclononane and related complexes (U.S. Pat. No. 4,246,612, U.S. Pat. No. 5,227,084); Co, Cu, Mn and Fe bispyridylamine and related complexes (U.S. Pat. No. 5,114,611); and pentamine acetate cobalt (III) and related complexes (U.S. Pat. No. 4,810,410). Bleach catalyst if included in the compositions of the invention are in a level of from about 0.1 to about 10%, from about 0.5 to about 2% by weight of the composition.

### Alkalinity

Examples of alkalinity source include, but are not limited to, an alkali hydroxide, alkali hydride, alkali oxide, alkali sesquicarbonate, alkali carbonate, alkali borate, alkali salt of mineral acid, alkali amine, alkaloid and mixtures thereof. In one embodiment, the alkalinity source is sodium carbonate, in another embodiment sodium hydroxide, in another embodiment potassium hydroxide. The alkalinity source is typically present in an amount sufficient to give the wash liquor a pH of from about 8 to about 12, from about 9 to about 11.5. The composition herein may comprise from about 1% to about 40%, from about 2% to 20% by weight of the composition of alkaline source.

### Water-Soluble Pouch

The composition of the invention can be in unit dose form, in particular in the form of a water soluble pouch. A non-limiting example of a pouch material includes polyvinyl alcohol. In one embodiment, the pouch comprises one compartment, alternatively two, or three or more compartments. In another embodiment, the pouches comprise at least two side-by-side compartments to form multi-compartment pouches. In one embodiment, the two compartments are superposed to one another. In one embodiment, at least one of the compartments contains a powder component and the other compartment contains a non-powder component. Non-powder components can be in the form of a gel or a liquid or an aqueous liquid.

### EXAMPLES

The foam volume of simplified automatic dishwashing compositions was measured with a SITA FOAM Tester R2000 (SITA), according to the method described herein.

To measure the foam volume of a simplified detergent composition, a solution is prepared as follow and is tested with the SITA method described herein. Adjusted water is firstly prepared from deionised water by adding 2.5 g/L of NaCl and 1M NaOH up to a pH of 10.3 at room temperature. The adjusted water is then heated to a temperature of 45° C. and the simplified detergent composition is added to the adjusted water at a total detergent concentration of 4 g/L.

To define whether a surfactant is “Low foaming” or “High foaming,” a solution is prepared as follow and is tested with the SITA method described herein. Adjusted water is firstly prepared from deionised water by adding 2.5 g/L of NaCl and 1M NaOH up to a pH of 10.3 at room temperature. The adjusted water is then heated to a temperature of 45° C. and the surfactant is added to this adjusted water at a level of 0.4 g/L on a 100% active weight basis. For each surfactant used in the examples below (high or low foaming), this value is stated in brackets in the introduction of the example.

### Example 1

Example 1 shows the maximum foam value for various simplified detergent compositions, including a high foaming non-ionic surfactant (MARLIPAL 24/70® from Sasol Corporation, Foam volume=346 mL), a low foaming non-ionic surfactant (PLURAFAC SLF180® by the BASF-Wyandotte Corp, Foam volume=0 mL), and/or a silicon based suds suppressor (KS-530® from Shin-Etsu Chemical Industry Co).

The suds suppressing action of the combination of Plurafac SLF180 and Shin-Etsu KS530 (composition D) is much higher than the level of suds suppressing action when using either Shin-Etsu (composition B) or Plurafac SLF180 (composition C) alone.

TABLE 1
Maximum foam volume obtained with simplified detergent
composition including a high foaming non-ionic surfactant

| | g active per dose of | | | |
|---|---|---|---|---|
| | detergent (4 g/L) | | | |
| | for each composition | | | |
| | A | B | C | D |
| Marlipal 24/70 (High foaming | 2 | 2 | 2 | 2 |
| non-ionic surfactant) | | | | |
| Plurafac SLF 180 (Low foaming | — | — | 1.578 | 1.56 |
| non-ionic surfactant) | | | | |
| Shinetsu KS530 (Silicon suds | — | 0.018 | — | 0.018 |
| suppressor) | | | | |
| Total “Low foaming non-ionic” + | 0 | 0.018 | 1.578 | 1.578 |
| “suds suppressor” | | | | |
| Foam volume (mL) | 346 | 107 | 51 | 17 |

### Example II

Example 2 shows the maximum foam value for various simplified detergent compositions, including a high foaming anionic surfactant (HLAS, Foam volume=745 mL), a low foaming non-ionic surfactant (PLURAFAC SLF180® by the BASF-Wyandotte Corp, Foam volume=0 mL), and/or a silicon based suds suppressor (KS-530® from Shin-Etsu Chemical Industry Co).

The suds suppressing action of the combination of Plurafac SLF180 and Shin-Etsu KS530 (composition D) is much higher than the level of suds suppressing action when using either Shin-Etsu KS530 (composition B) or Plurafac SLF180 (composition C) alone.

TABLE 2
Maximum foam volume obtained with simplified detergent
composition including a high foaming anionic surfactant

| | g active per dose of | | | |
|---|---|---|---|---|
| | detergent (4 g/L) | | | |
| | for each composition | | | |
| | A | B | C | D |
| HLAS (high foaming anionic surfactant) | 0.5 | 0.5 | 0.5 | 0.5 |
| Plurafac SLF 180 (Low foaming | — | — | 1.632 | 1.56 |
| non-ionic surfactant) | | | | |
| Shinetsu KS530 (Silicon suds | — | 0.072 | — | 0.072 |
| suppressor) | | | | |
| Total “Low foaming non-ionic” + “suds | 0 | 0.072 | 1.632 | 1.632 |
| suppressor” | | | | |
| Foam Volume (mL) | 669 | 93 | 211 | 3 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to the term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An automatic dishwashing detergent composition comprising:
a) from about 0.1% to about 20% by weight of a high foaming surfactant;
b) from about 0.5% to about 15% by weight of a low foaming non-ionic surfactant;
c) from about 0.001% to about 5% by weight of a suds suppressor; and
d) from about 1% to about 50% of a builder,
wherein said automatic dishwashing detergent has a foam volume less than about 30 ml per 250 mL of a 4.0 g/L detergent solution at 45° C. according to the test method described herein.

2. A composition according to claim 1, wherein said high foaming surfactant is selected from the group consisting of a non-ionic surfactant, an anionic surfactant, a zwitterionic surfactant, a cationic surfactant, an amphoteric surfactant, and mixtures thereof.

3. A composition according to claim 2 wherein said high foaming surfactant is selected from the group consisting of an alkylpolyglucoside, an alcohol alkoxylate, an alkylbenzene sulfonate, a paraffin sulfonate, an alkyl sulfate, an alkylethoxysulfate, an amine oxide, a betaine, a derivative thereof, and mixtures thereof.

4. A composition according to claim 4, wherein said high foaming surfactant is an alkyl alcohol alkoxylate having a cloud point of greater than about 40° C.

5. A composition according to claim 2, wherein the high foaming nonionic surfactant is an ethoxylated alcohol, or an ethoxylated-propoxylated alcohol with an HLB value of greater than 10.

6. A composition according to claim 1, wherein said low foaming non-ionic surfactant has a cloud point of less than about 40° C.

7. A composition according to claim 6, wherein said low foaming non-ionic surfactant has the formula:
R1(EO)a(PO)b(BO)c
wherein R1 is a linear or branched C6 to C20 alkyl; a is from about 2 to about 30; b is from 0 to about 30; c is from about 0 to about 30 and wherein both b and c cannot both be simultaneously 0, and when b is greater than 0 and c equal to 0, then the surfactant has a HLB value of less than about 10.

8. A composition according to claim 1, wherein said suds suppressor is selected from the group consisting of a silicone fluid, a silicone resin, silica, and mixtures thereof.

9. A composition according to claim 8, wherein the suds suppressor comprises a polysiloxane substituted by one or more moieties selected from the group consisting of an alkyl, an aryl, and mixtures thereof.

10. A composition according to claim 9, wherein said suds suppressor comprises dimethylpolysiloxane, a hydrophilic polysiloxane compound having polyethylenoxy-propylenoxy group in the side chain, and a micro-powdery silica.

11. A composition according to claim 8, wherein said suds suppressor is in the form of a granule or a liquid.

12. A composition according to claim 1, wherein the builder is selected from the group consisting of carboxylates, phosphates, and mixtures thereof.

13. A composition according to claim 1, further comprising an additional ingredient selected from the group consisting of a bleach, a bleach activator, an enzyme, a metal care agent, a polymer, and combinations thereof.

14. A composition according to claim 1, wherein the weight ratio of suds suppressor, low foaming non-ionic surfactant, and high foaming surfactant is from about 1:9:3 to about 1:35:11, and wherein the high foaming surfactant is anionic.

15. A method of cleaning dishware comprising the step of providing a composition according to claim 1 in an automatic dishwashing cycle.

16. A method of cleaning dishware according to claim 15, wherein the dishwashing cycle is a cold water cycle.
